(19) United States
(12) Patent Application Publication
(10) Pub. No.: US 2024/0096344 A1
(43) Pub. Date: Mar. 21, 2024

(54) MANAGING AUDIO CONFLICTS IN WEB CONFERENCES

(71) Applicant: International Business Machines Corporation, Armonk, NY (US)

(72) Inventors: Wei Jun Zheng, Shanghai (CN); Shi Kun Li, Shanghai (CN); Shuai Cao, Shanghai (CN); Fan Xiao Xin, Shanghai (CN); Ying Li, Shanghai (CN)

(73) Assignee: International Business Machines Corporation, Armonk, NY (US)

(21) Appl. No.: 17/946,500

(22) Filed: Sep. 16, 2022

(51) Int. Cl. G10L 21/0272; G10L 15/26; G10L 25/78

(52) U.S. Cl. CPC G10L 21/0272; G10L 15/26; G10L 25/78

(57) ABSTRACT

An embodiment includes identifying, during a video conference attended by a first attendee, other attendees of the video conference. The embodiment renders a virtual meeting environment including virtual representations of the other attendees, where the rendering includes accessing relationship characteristic data indicative of relationships between the first attendee and other attendees. The embodiment calculates positions for virtual representations of the other attendees in the first attendee's virtual field of view based on the relationship characteristic data. The embodiment also detects simultaneous speech from two of the other attendees and, in response, directs the individual speech from each of the other attendees to respective audio channels.

### BACKGROUND

The present invention relates generally to a method, system, and computer program product for data processing. More particularly, the present invention relates to a method, system, and computer program product for managing audio conflicts in web conferences.

Web conferences continue to become an increasingly popular way for two or more individuals to communicate. A web conference is a form of an electronic meeting that is usually facilitated by a web conferencing system. A web conferencing system typically includes features that facilitate speech-, text-, and/or video-enabled communication sessions among a plurality of individuals. A web conferences may include a presentation of audio-visual (and/or other) by presenters to other conference attendees. Web conferences allow for meetings between two or more individuals who are located in different locations such that an in-person meeting may not be practical. Web conferences allow a meeting to be conducted “virtually” such that the two or more participants interact with one another remotely.

### SUMMARY

The illustrative embodiments provide for managing audio conflicts in web conferences. An embodiment includes identifying, during a video conference attended by a first attendee, other attendees of the video conference. The embodiment also includes rendering, during the video conference as a display to the first attendee, a virtual meeting environment including virtual representations of the other attendees of the video conference, where the rendering includes accessing relationship characteristic data indicative of relationships between the first attendee and the other attendees, and calculating positions for virtual representations of the other attendees in the first attendee's virtual field of view based at least in part on the relationship characteristic data. The embodiment also includes detecting, in speech streamed to the first attendee during the video conference, simultaneous speech from at least two of the other attendees, where the simultaneous speech comprises individual speech from a second attendee and individual speech from a third attendee. The embodiment also includes directing, responsive to detecting the simultaneous speech, the individual speech from the second attendee to a first audio channel and the individual speech from the third attendee to a second audio channel. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of a web conferencing environment that includes a service infrastructure in accordance with an illustrative embodiment;

FIG. 3 depicts a block diagram of example web conferencing environment for providing functionality described herein that can be utilized with an audio management system in accordance with illustrative embodiments;

FIG. 4 depicts a block diagram of example web conferencing environment for providing functionality described herein that can be utilized with an audio management system in accordance with illustrative embodiments;

FIG. 5 depicts a block diagram of an example web conferencing environment for providing functionality described herein that can be utilized with an audio management system in accordance with illustrative embodiments;

FIG. 6 depicts a block diagram of an example web conferencing environment for providing functionality described herein that can be utilized with an audio management system in accordance with illustrative embodiments;

FIG. 7 depicts a block diagram of an example web conferencing environment for providing functionality described herein that can be utilized with an audio management system in accordance with illustrative embodiments;

FIG. 8 depicts a block diagram of an example web conferencing environment for providing functionality described herein that can be utilized with an audio management system in accordance with illustrative embodiments;

FIG. 9 depicts a block diagram of an example audio management system in accordance with an illustrative embodiment; and

FIG. 10 depicts a flowchart of an example process for managing audio conflicts in web conferences in accordance with an illustrative embodiment.

### DETAILED DESCRIPTION

Web conferencing provides a popular way for two or more individuals to communicate over long distances. However, web conferencing presents certain challenges due to occasional delays in the transmission of audio and users often find it difficult to notice non-verbal cues that suggest that another user is about to speak. Existing conferencing systems connect the conference participants in real time and are designed to play the same audio or video to all participants in real time. However, network congestion and other delays create offsets in this timing, which frequently leads to users inadvertently interrupting or talking over others.

When interruptions such as this occur during a web conference, they can be very distracting and can degrade the ability of users to carry on an ordinary conversation. Users may tend to get distracted by the difficulty in timing their speech that they lose focus on the topic of the conversation. In addition, existing web conferencing software is limited in that all attendees are grouped into a single conversation and are therefore unable to easily split off into groups without transitioning to separate calls completely.

The illustrative embodiments recognize that there is a need to provide improved techniques for managing simultaneous speaker scenarios and enhancing the capabilities of web conferencing software and systems to allow for simultaneous speakers without causing distractions or disruptions. Disclosed embodiments enable the opportunity to allow concurrent speakers to continue to talk without stopping, waiting, or repeating their words. Disclosed embodiments also allow attendees to control the volume of other attendees on an individual level, which makes it possible for attendees to small groups to have separate discussions without interrupting any speakers. Disclosed embodiments provide these features through the use of various audio management techniques described herein.

In some embodiments, the audio management provides web conference attendees with a visual indication of current audio management processes or settings. In an illustrative embodiment, an audio management process renders virtual environments as a display for web conference attendees. In an illustrative embodiment, the virtual environment is a virtual meeting environment that depicts virtual representations of the other web conference attendees. In some embodiments, an audio management process sets respective volume levels at which an attendee will hear each of the other attendees such that the attendee will hear some attendees louder than others. The audio management process then depicts the virtual representations of the other web conference attendees at respective distances according to their volume levels. In some embodiments, the distance is inversely related to volume level such that relatively louder attendees (having a relatively higher volume) appear relatively closer than other attendees having a relatively lower volume.

In some embodiments, an audio management process calculates distance values for each of the other web conference attendees based on their respective volume levels. In some such embodiments, an audio management process then positions the representations of the other web conference attendees using a coordinate system. For example, in an illustrative embodiment, an audio management process uses a Cartesian coordinate system and the calculated distances along with angles selected to distribute the other attendees across the display of the virtual environment.

In some embodiments, an audio management process sets the volume levels and distances used for an attendee according to characteristics of the relationships between an attendee and each of the other attendees. In some embodiments, an audio management process determines the relationship characteristics based on relationship characteristic data, for example social network data and/or historical meeting data. In some embodiments, an audio management process accesses the social network data that is representative of social network relationships between an attendee and the other attendees.

In some embodiments, an audio management process calculates degrees of associations between an attendee and each of the other attendees based at least in part on the social network relationship data. For example, in some embodiments, an audio management process calculates degrees of associations based on whether another attendee is an immediate friend (or acquaintance) of an attendee, or a friend of one of the attendee's immediate friends, or a member of a same affinity group as an attendee, or a member of a directly related affinity group, etc. In various embodiments, the degrees of associations between different attendees may be different depending upon which metrics for relationship characteristics are used.

In some embodiments, an audio management process calculates degrees of associations between an attendee and each of the other attendees based at least in part on other data, such as historical meeting data or other data that may be indicative of relationships, common goals, common interests, etc. For example, in some embodiments, an audio management process may assign numeric values associated with the similarities such as attendees that have historically attended the same meetings because they work in a same group or department, work on a same project, or have similar work-related goals or interests. In some embodiments, an audio management process may consider data indicative of the “importance” of the relationships between the attendees based on the frequency of communications between the attendees, the frequency and/or quality of business relationships between the attendees, and the like.

In some embodiments, an audio management process adjusts the volume levels based on user inputs. For example, an attendee may wish to hear a topic that another attendee is presenting and input a volume adjustment command to raise the volume of that attendee and/or lower the volume of other attendees. In some such embodiments, an audio management process makes the volume adjustment and then updates the arrangement of the attendees in the virtual environment so that the distance to the other attendee is shorter to reflect the increased volume for the attendee.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. The steps described by the various illustrative embodiments can be adapted for providing explanations for decisions made by a machine-learning classifier model, for example.

Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, contrastive explanations, computer readable storage medium, high-level features, training data, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures, therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

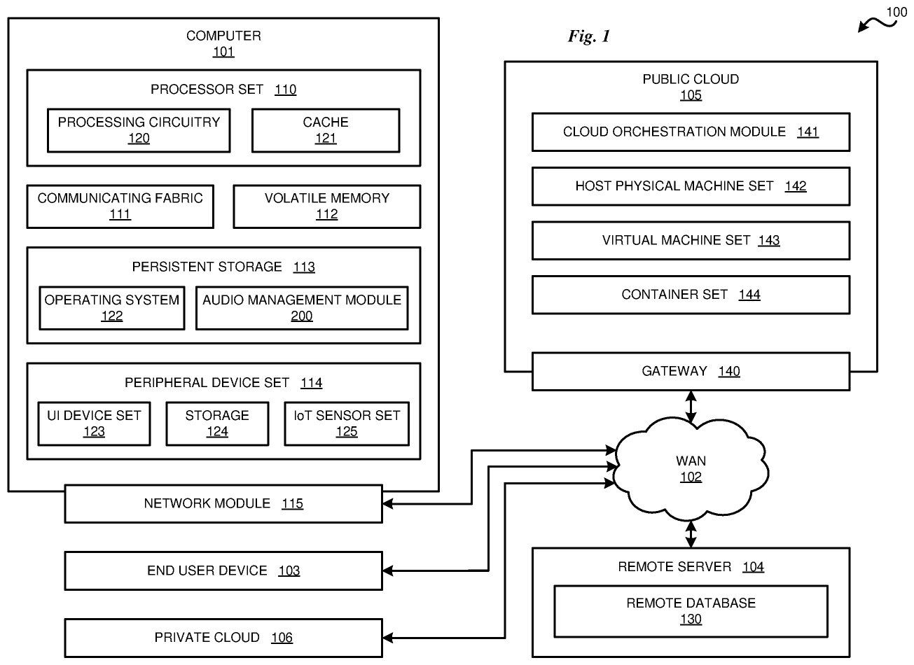

With reference to FIG. 1, this figure depicts a block diagram of a computing environment 100. Computing environment 100 contains an example of an environment for the execution of at least some of the computer code involved in performing the inventive methods, such as an improved audio management module 200 that provides improved techniques for managing simultaneous speaker scenarios and enhancing the capabilities of web conferencing software and systems to allow for simultaneous speakers without causing distractions or disruptions. In addition to audio management module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and audio management module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in audio management module 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in audio management module 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

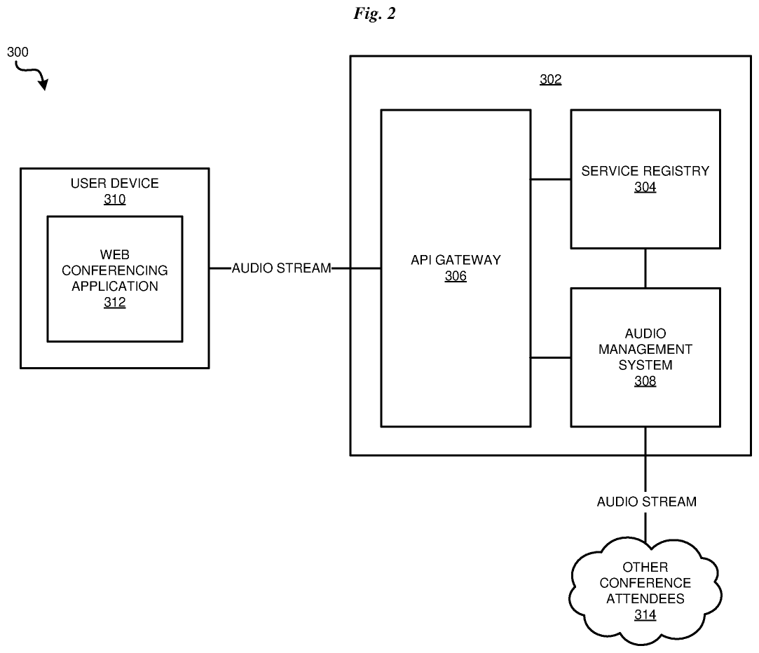

With reference to FIG. 2, this figure depicts a block diagram of a web conferencing environment 300 that includes a service infrastructure 302 in accordance with an illustrative embodiment. The service infrastructure 302 includes an audio management system 308 that, in some embodiments, includes an audio management module 200 of FIG. 1.

In the illustrated embodiment, the service infrastructure 302 provides audio management services and service instances to a user device 310. In some embodiments, the user device 310 is an example of an end user device 103 of FIG. 1. User device 310 includes a web conferencing application 312 that enables the user device 310 to communicate with other conference attendees 314. In some embodiments, the web conferencing application 312 allows a user to engage in web conferencing, share files, make presentations, share virtual white boards, desktops, and other data, while simultaneously conducting voice communications with other conference attendees 314.

Audio management system 308 provides audio management services at infrastructure 302 via an application programming interface (API) gateway 306. In various embodiments, service infrastructure 302 and its associated audio management system 308 serve multiple users and multiple tenants. A tenant is a group of users (e.g., a company) who share a common access with specific privileges to the software instance. Service infrastructure 302 ensures that tenant specific data is isolated from other tenants.

In some embodiments, user device 310 connects the web conferencing application 312 with API gateway 306 via any suitable network or combination of networks such as the Internet, etc. and use any suitable communication protocols such as Wi-Fi, Bluetooth, etc. Service infrastructure 302 may be built on the basis of cloud computing. API gateway 306 provides access to client applications like audio management system 308. API gateway 306 receives service requests issued by client applications, such as web conferencing application 312, and creates service lookup requests based on service requests.

In the illustrated embodiment, service infrastructure 302 includes a service registry 304. In some embodiments, service registry 304 looks up service instances of audio management system 308 in response to a service lookup request such as one from API gateway 306 in response to a service request from user device 310. For example, in some embodiments, the service registry 304 looks up service instances of audio management system 308 in response to requests from the user device 310 related to audio management services. In some embodiments, the web conferencing application 312 issues an API hook to the API gateway 306 that causes the audio management system 308 to commence management of an audio stream from the web conferencing application 312.

In some embodiments, the service infrastructure 302 includes one or more instances of the audio management system 308. In some such embodiments, each of the multiple instances of the audio management system 308 run independently on multiple computing systems. In some such embodiments, audio management system 308, as well as other service instances of audio management system 308, are registered in service registry 304.

In some embodiments, service registry 304 maintains information about the status or health of each service instance including performance information associated each of the service instances. For example, such performance information may include several types of performance characteristics of a given service instance (e.g., cache metrics, etc.). In some embodiments, the extended service registry 304 ranks service instances based on their respective performance characteristics and selects top-ranking service instances for classification requests. In some such embodiments, in the event that a service instance becomes unresponsive or, unhealthy, the service registry will no longer provide its address or information about this service instance to other services.

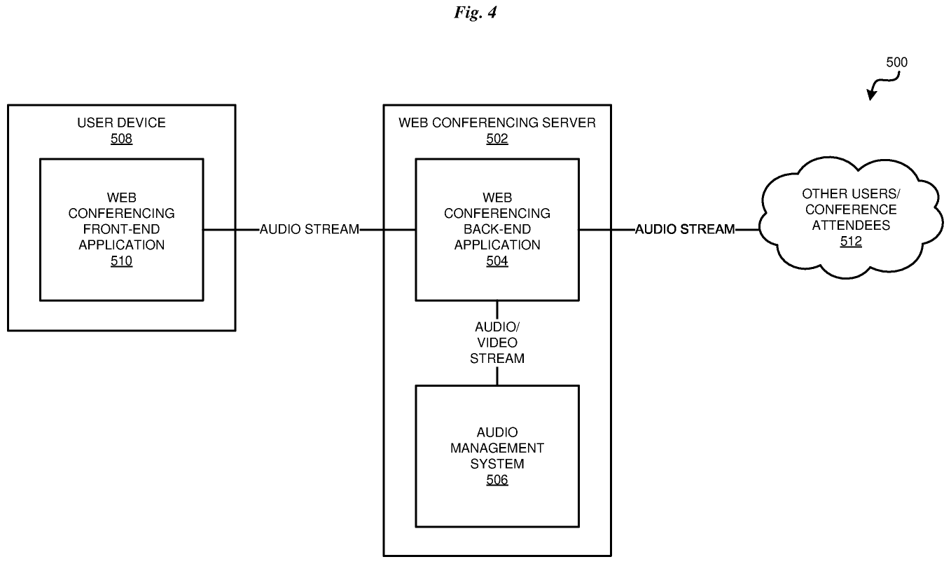

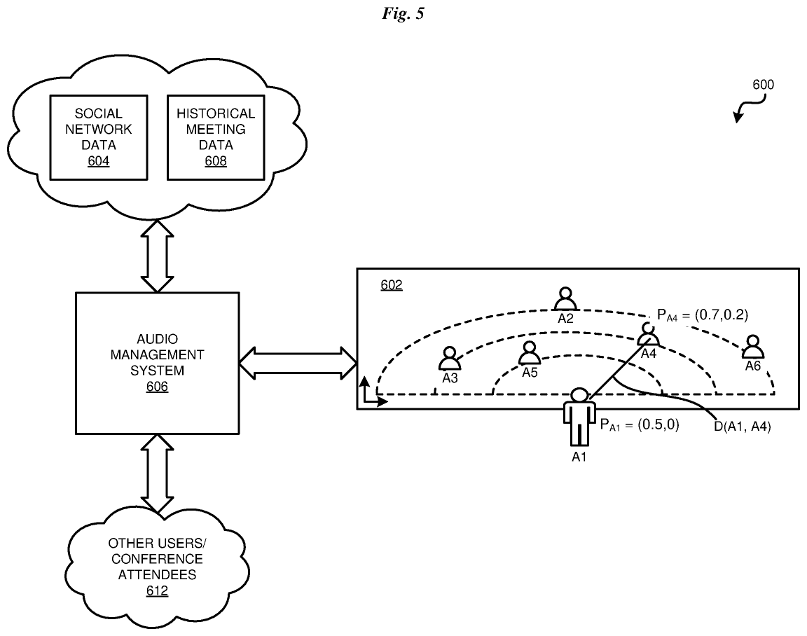

The functionality provided by the audio management system 308 is not limited to the arrangement shown in FIG. 2. Many other system arrangements or architectures are used in alternative embodiments, including the alterative embodiments shown in FIGS. 4 and 5.

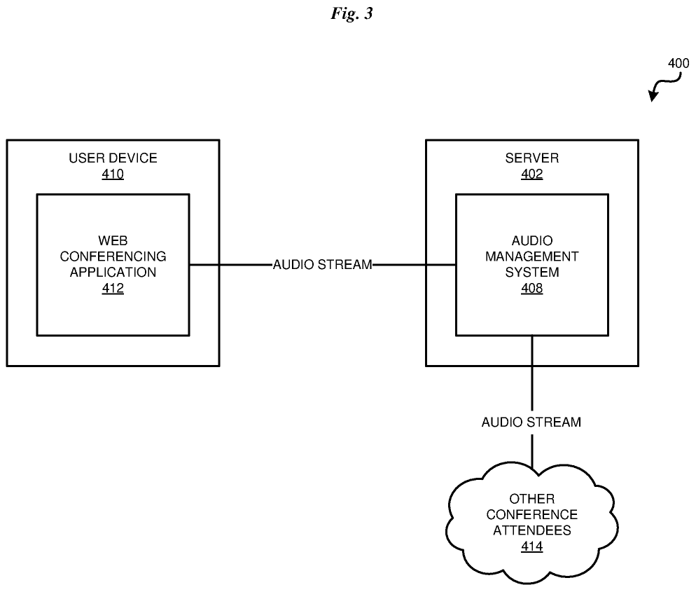

With reference to FIG. 3, this figure depicts a block diagram of example web conferencing environment 400 for providing functionality described herein that can be utilized with an audio management system 408 in accordance with illustrative embodiments. The web conferencing environment 400 includes a server 402 that hosts the audio management system 408. In some embodiments, the server 402 is a web conferencing server associated with the web conferencing application 412 and the audio management system 408 is a module or add-in for the web conferencing application 412. In some embodiments, the server 402 is a web server that provides audio management services via the audio management system 408.

In the illustrated embodiment, the server 402 provides audio management services to a user device 410. In some embodiments, the user device 410 is an example of an end user device 103 of FIG. 1. User device 410 includes a web conferencing application 412 that enables the user device 410 to communicate with other conference attendees 414. The audio management system 408 provides audio management services for the user device 410.

In some embodiments, the web conferencing application 412 issues a web hook to the server 402, for example by transmitting a POST that includes a unique and identifiable token to the server 402. The web hook triggers the audio management system 408 to connect to a web conference that the user of the user device 410 is attending or hosting via the web conferencing application 412. In some embodiments, the audio management system 408 may connect to the web conference in the same manner as the other conference attendees 414. Once connected, the audio management system 408 begins managing the audio stream of the web conference.

With reference to FIG. 4 this figure depicts a block diagram of example web conferencing environment 500 for providing functionality described herein that can be utilized with an audio management system 506 in accordance with illustrative embodiments. The web conferencing environment 500 includes a web conferencing server 502 that provides back-end functionality for web conferencing. In the illustrated embodiment, the back-end web conferencing support includes audio management provided by the audio management system 506.

In some embodiments, the user device 508 is an example of an end user device 103 of FIG. 1. User device 508 includes a web conferencing application 510 that enables the user device 508 to communicate with other conference attendees 512. The audio management system 506 provides audio management services for the user device 508.

In some embodiments, the web conferencing application 510 connects to a web conference that is broadcast by the web conferencing back-end application 504. The web conference may be open to the public or may have restricted access. In the latter case, the web conferencing front-end application 510 may provide credentials to the web conferencing back-end application 504 in order to join the web conference. In some embodiments, the web conferencing back-end application 504 may trigger the audio management system 506 to begin managing the audio for the web conference upon detecting the start of the web conference. In some embodiments, the web conferencing back-end application 504 may trigger the audio management system 506 to begin managing the audio of the web conference upon detecting a request for audio management services from a user, such as the web conference host. Once audio management has been triggered, the web conferencing back-end application 504 begins providing the audio stream of the web conference to the audio management system 506. The audio management system 506 then manages the audio stream.

With reference to v 5, this figure depicts a block diagram of an example web conferencing environment 600 for providing functionality described herein that can be utilized with an audio management system 606 in accordance with illustrative embodiments. In some embodiments, the audio management system 606 is an example of the audio management system 308 of FIG. 2, audio management system 408 of FIG. 3, or the audio management system 506 of FIG. 4.

In some embodiments, the audio management system 606 allows concurrent speakers to continue to talk without stopping, waiting, or repeating their words, and allows meeting attendees to form small groups to have separate conversations concurrently without interrupting any other speaker or conversation. The audio management system 606 provides these features through the use of various audio management techniques described herein. In some embodiments, the audio management system 606 provides web conference attendees with a visual indication of current audio management processes or settings.

In the illustrated embodiment, the audio management system 606 renders virtual environment 602 as a display for a web conference attendee A1. While FIG. 5 only shows the virtual environment 602 that the audio management system 606 renders for attendee A1, in some embodiments, the audio management system 606 also renders additional virtual environments that are customized for, and displayed to, each of the other attendees 612.

In the illustrated embodiment, the virtual environment 602 is a virtual meeting environment that depicts virtual representations of the other web conference attendees A2-A6. In some embodiments, the audio management system 606 sets respective volume levels at which A1 will hear each of the other attendees A2-A6 such that A1 will hear some attendees louder than others. The audio management system 606 then depicts the virtual representations of the other web conference attendees A2-A6 at respective distances according to their volume levels. In some embodiments, the distance is inversely related to volume level such that relatively louder attendees (having a relatively higher volume) appear relatively closer than other attendees having a relatively lower volume.

In some embodiments, the audio management system 606 calculates distance values for each of the other web conference attendees A2-A6 based on their respective volume levels. In some such embodiments, the audio management system 606 then positions the representations of the other web conference attendees A2-A6 using a coordinate system. For example, in the illustrated embodiment, the audio management system 606 uses a Cartesian coordinate system and the calculated distances along with angles selected to distribute the other attendees across the display of the virtual environment 602. Using a respective angle G_{An} and a respective calculated distance D(A1, An) from attendee A1, a set of coordinates P_{An}=(x, y) may be calculated for each of the n other attendees A2-A6 using Expressions (1) and (2) below.

x=0.5*[1−D(A1,An)*cos(G_{An})] (1)

y=0.5*D(A1,An)*sin(G_{An}) (2)

As an example, the attendee A4 has a volume level that is louder than that of attendees A2 and A6 but quieter than that of attendee A5. Therefore, the audio management system 606 positions the representation of attendee A4 at P_{A4}=(0.7, 0.2) at some distance D(A1,A4) and angle G_{A4}.

In some embodiments, the audio management system 606 sets the volume levels and distances used for attendee A1 according to characteristics of the relationships between attendee A1 and each of the other attendees. In some embodiments, the audio management system 606 determines the relationship characteristics based on relationship characteristic data, for example social network data 604 and/or historical meeting data 608. In some embodiments, the audio management system 606 access the social network data 604 that is representative of social network relationships between the first attendee A1 and the other attendees A2-A6.

In some embodiments, the audio management system 606 calculates degrees of associations between the first attendee A1 and each of the other attendees A2-A6 based at least in part on the social network relationship data. For example, in some embodiments, the audio management system 606 calculates degrees of associations based on whether another attendee is an immediate friend (or acquaintance) of the attendee A1, or a friend of one of the attendee A1's immediate friends, or a member of a same affinity group as attendee A1, or a member of a directly-related affinity group, etc. In various embodiments, the degrees of associations between different attendees may be different depending upon which metrics for relationship characteristics are used.

In some embodiments, the audio management system 606 calculates degrees of associations between the first attendee A1 and each of the other attendees A2-A6 based at least in part on other data, such as historical meeting data 608 or other data that may be indicative of relationships, common goals, common interests, etc. For example, in some embodiments, the audio management system 606 may assign numeric values associated with the similarities such as attendees that have historically attended the same meetings because they work in a same group or department, work on a same project, or have similar work-related goals or interests. In some embodiments, the audio management system 606 may consider data indicative of the “importance” of the relationships between the attendees based on the frequency of communications between the attendees, the frequency and/or quality of business relationships between the attendees, and the like.

In some embodiments, the audio management system 606 adjusts the volume levels based on user inputs. For example, attendee A1 may wish to hear a topic that attendee A2 is presenting and input a volume adjustment command to raise the volume of attendee A2 and/or lower the volume of other attendees. In some such embodiments, the audio management system 606 makes the volume adjustment and then updates the arrangement of the attendees in the virtual environment 602 so that the distance to attendee A2 is shorter to reflect the increased volume for attendee A2.

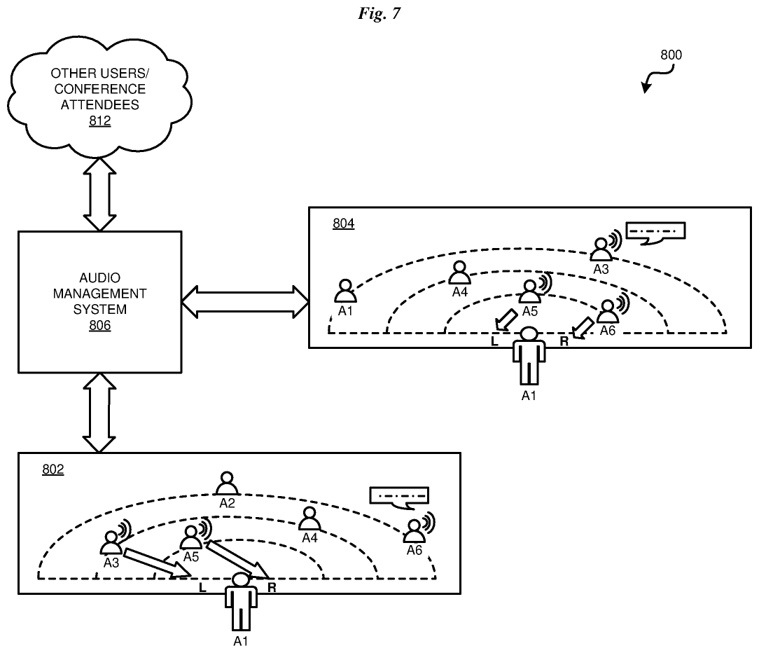

FIGS. 7-9 illustrate examples of different modes of operation for various embodiments of the audio management system. In some embodiments, the audio management system 606 is configurable to operate in one of the modes of operation described below in connection with FIGS. 7-9.

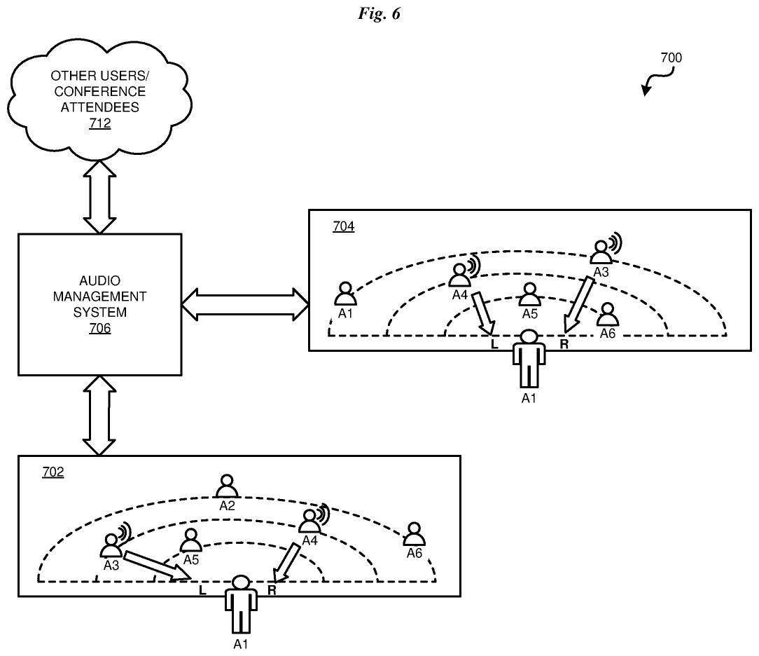

With reference to FIG. 6, this figure depicts a block diagram of an example web conferencing environment 700 for providing functionality described herein that can be utilized with an audio management system 706 in accordance with illustrative embodiments. In some embodiments, the audio management system 706 is an example of the audio management system 606 of FIG. 5, the audio management system 308 of FIG. 2, audio management system 408 of FIG. 3, or the audio management system 506 of FIG. 4.

In the illustrated embodiment, the audio management system 706 operates in a first free chat mode. In the first free chat mode, the audio management system 706 detects when two attendees are speaking at the same time and reacts by sending audio from one of the speaking attendees to the left audio channel and sending audio from the other speaking attendee to the right audio channel.

In the illustrated embodiment, the audio management system 706 has rendered virtual environment 702 for attendee A1 and has rendered virtual environment 704 for attendee A2. While FIG. 6 only shows the virtual environment 702 and virtual environment 704 that the audio management system 706 renders for attendees A1 and A2, respectively, in some embodiments, the audio management system 706 also renders additional virtual environments that are customized for, and displayed to, each of the other attendees 712.

While attendees A1 and A2 are attending the same web conference, the virtual environment 702 shows a different arrangement of other attendees compared to that of the virtual environment 704. As discussed in connection with FIG. 5, the audio management system 706 renders a unique virtual environment for each attendee in which the other attendees are arranged according to volume levels and relationship characteristics with the viewing attendee.

In the illustrated embodiment, the audio management system 706 detects that attendees A3 and A4 are speaking simultaneously. The audio management system 706 responds by sending audio from one of the speaking attendees to the left audio channel and sending audio from the other speaking attendee to the right audio channel. This allows other attendees the option of listening to both speak or selecting one to listen to by listening to only the right or left channel. As shown in FIG. 6, in some embodiments, the audio management system 706 sends the audio from the two speaking attendees to respective different audio channels, but the channel that one attendee is on may differ for different attendees based on where the two speaking attendees are displayed. For example, for attendee A1, audio for attendee A3 is received in the left channel and for attendee A4 in the right channel, which matches where attendees A3 and A4 are seen by attendee A1 in the virtual environment 702. However, for attendee A2, audio for attendee A4 is received in the left channel and for attendee A3 in the right channel, which matches where attendees A3 and A4 are seen by attendee A2 in the virtual environment 704.

With reference to FIG. 7, this figure depicts a block diagram of an example web conferencing environment 800 for providing functionality described herein that can be utilized with an audio management system 806 in accordance with illustrative embodiments. In some embodiments, the audio management system 806 is an example of the audio management system 606 of FIG. 5, the audio management system 308 of FIG. 2, audio management system 408 of FIG. 3, or the audio management system 506 of FIG. 4.

In the illustrated embodiment, the audio management system 806 operates in a second free chat mode. In the second free chat mode, the audio management system 806 detects when more than two attendees are speaking at the same time and reacts by sending audio from one of the speaking attendees to the left audio channel, sending audio from another speaking attendee to the right audio channel, and converting the speech from other speaking attendees to text that is displayed.

In the illustrated embodiment, the audio management system 806 has rendered virtual environment 802 for attendee A1 and has rendered virtual environment 804 for attendee A2. While FIG. 7 only shows the virtual environment 802 and virtual environment 804 that the audio management system 806 renders for attendees A1 and A2, respectively, in some embodiments, the audio management system 806 also renders additional virtual environments that are customized for, and displayed to, each of the other attendees 812.

In the illustrated embodiment, the audio management system 806 detects that attendees A3, A5, and A6 are speaking simultaneously. The audio management system 806 responds by sending audio from one of the speaking attendees to the left audio channel, sending audio from another speaking attendee to the right audio channel, and converting the speech from other speaking attendees to text that is displayed. This allows other attendees the option of listening to both speak or selecting one to listen to by listening to only the right or left channel. As shown in FIG. 7, in some embodiments, the audio management system 806 sends the audio from the two speaking attendees to respective different audio channels, but the speaking attendees that one attendee hears in the left and right channels may differ for different attendees based on how the attendees have prioritized other attendees. For example, attendee A1 has prioritized attendees A3 and A5 higher than attendee A6, so the audio management system 806 sends audio for attendee A3 to the left channel and for attendee A5 to the right channel, while speech from attendee A6 is converted to text. However, attendee A2 has prioritized attendees A5 and A5 higher than attendee A3, so the audio management system 806 sends audio for attendee A5 to the left channel and for attendee A6 to the right channel, while speech from attendee A3 is converted to text.

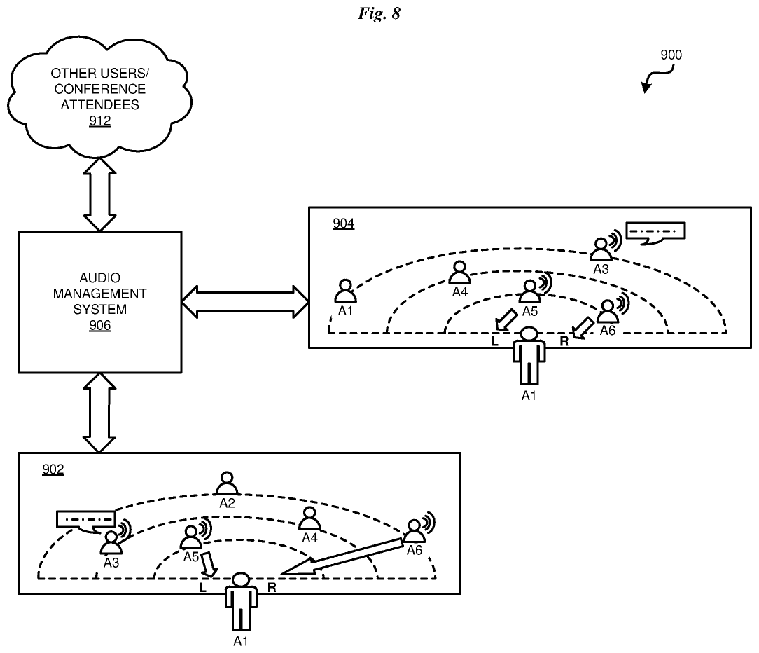

With reference to FIG. 8, this figure depicts a block diagram of an example web conferencing environment 900 for providing functionality described herein that can be utilized with an audio management system 906 in accordance with illustrative embodiments. In some embodiments, the audio management system 906 is an example of the audio management system 606 of FIG. 5, the audio management system 308 of FIG. 2, audio management system 408 of FIG. 3, or the audio management system 506 of FIG. 4.

In the illustrated embodiment, the audio management system 906 operates in a unified mode. In the unified mode, the audio management system 906 ranks the attendees A1-A6 by calculating the weighted sum of all attendees' settings for virtual distances to others. The audio management system 906 renders virtual environments that are customized for, and displayed to, each of the attendees, including virtual environment 902 and virtual environment 904 as well as additional virtual environments for each of the other attendees 912. Each virtual environment has a unique arrangement of other attendees at various distances as described in connection with FIG. 5. Thus, all six attendees A1-A6 have their own set of distance settings for the other attendees. In the illustrated embodiment, the audio management system 906 calculates a weighted sum that results in an ordered list. When the audio management system 906 thereafter detects that more than two attendees are speaking at the same time, the audio management system 906 reacts by sending audio from one of the speaking attendees to the left audio channel, sending audio from another speaking attendee to the right audio channel, and converting the speech from other speaking attendees to text that is displayed. In the unified mode, the audio management system 906 determines which two attendees will have their speech sent to the left or right audio channel based on the ordered list.

In the illustrated embodiment, the audio management system 906 has rendered virtual environment 902 for attendee A1 and has rendered virtual environment 904 for attendee A2. While FIG. 8 only shows the virtual environment 902 and virtual environment 904 that the audio management system 906 renders for attendees A1 and A2, respectively, in some embodiments, the audio management system 906 also renders additional virtual environments that are customized for, and displayed to, each of the other attendees 912.

In the illustrated embodiment, the audio management system 906 detects that attendees A3, A5, and A6 are speaking simultaneously. The audio management system 906 responds by checking the ordered list calculated from the weighted sum of all attendees' settings for virtual distances to others. In the illustrated example, the ordered list has attendees A5 and A6 at higher priority levels that attendee A3. Therefore, the audio management system 906 sends audio of attendee A5 to one of the left and right channels and sends audio of attendee A6 to the other of the left and right channels, and converts speech from attendee A3 to text that is displayed.

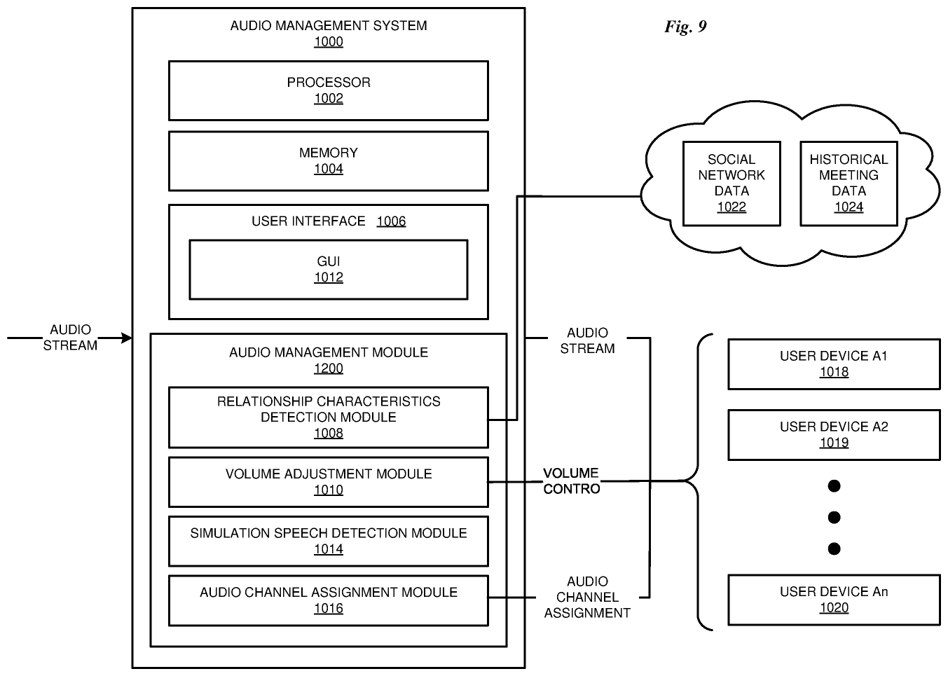

With reference to FIG. 9, this figure depicts a block diagram of an example audio management system 1000 in accordance with an illustrative embodiment. In a particular embodiment, the audio management system 1000 is an example of the audio management system 308 of FIG. 2 or any of the other embodiments disclosed herein of the audio management system.

In some embodiments, the audio management system 1000 includes a processor 1002, memory 1004, a user interface 1006 that includes a graphical user interface (GUI) 1012, and an audio management module 1200 that includes a relationship characteristics detection module 1008, a volume adjustment module 1010, a simultaneous speech detection module 1014, and an audio channel assignment module 1016. In some embodiments, the audio management module 1200 is an example of the audio management module 200 of FIG. 1. In alternative embodiments, the audio management system 1000 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the processing unit (“processor”) 1002 performs various computational and data processing tasks, as well as other functionality. The processing unit 1002 is in communication with memory 1004. In some embodiments, the memory 1004 comprises one or more computer readable storage media with program instructions collectively stored on the one or more computer readable storage media, with the program instructions being executable by one or more processors 1002 to cause the one or more processors 1002 to perform operations described herein.

In the illustrated embodiment, the user interface 1006 provides a point of human interaction with the audio management system 1000. For example, in the illustrated embodiment, the user interface 1006 communicates with user devices 1018-1020. In some embodiments, the user devices 1018-1020 are examples of the end user device 103 of FIG. 1.

In the illustrated embodiment, the volume adjustment module 1010 sets the volume levels and distances used for the attendees according to characteristics of the relationships between the attendees. In the illustrated embodiment, the relationship characteristics detection module 1008 provides the volume adjustment module 1010 with relationship characteristic data. The relationship characteristics detection module 1008 determines the relationship characteristics based on relationship characteristic data, for example from social network data 1022 and/or historical meeting data 1024. In some embodiments, the relationship characteristics detection module 1008 accesses the social network data 1022 that is representative of social network relationships between the each of the attendees.

In some embodiments, the relationship characteristics detection module 1008 calculates degrees of associations between each attendee and each of the other attendees based at least in part on the social network relationship data. For example, in some embodiments, the relationship characteristics detection module 1008 calculates degrees of associations based on whether another attendee is an immediate friends (or acquaintance) of another attendee, or a friend of an attendee immediate friends, or a member of a same affinity group as another attendee, or a member of a directly-related affinity group, etc. In various embodiments, the degrees of associations between different attendees may be different depending upon which metrics for relationship characteristics are used.

In some embodiments, the relationship characteristics detection module 1008 calculates degrees of associations between each attendee and each of the other attendees based at least in part on other data, such as historical meeting data 1024 or other data that may be indicative of relationships, common goals, common interests, etc. For example, in some embodiments, the relationship characteristics detection module 1008 may assign numeric values associated with the similarities such as attendees that have historically attended the same meetings because they work in a same group or department, work on a same project, or have similar work-related goals or interests. In some embodiments, the relationship characteristics detection module 1008 may consider data indicative of the “importance” of the relationships between the attendees based on the frequency of communications between the attendees, the frequency and/or quality of business relationships between the attendees, and the like.

In the illustrated embodiment, the volume adjustment module 1010 sets respective volume levels at which an attendee will hear each of the other attendees such that some attendees will be provided at a higher volume than others. In some embodiments, the volume adjustment module 1010 adjusts the volume levels based on user inputs. For example, attendee A1 operating user device A1 1018 may wish to hear a topic that attendee A2 (operating user device A2 1019) is presenting and input a volume adjustment command to raise the volume of attendee A2 and/or lower the volume of other attendees.

In the illustrated embodiment, the simultaneous speech detection module 1014 detects that two or more attendees are speaking simultaneously. The simultaneous speech detection module 1014 responds by sending audio from one of the speaking attendees to the left audio channel and sending audio from the other speaking attendee to the right audio channel as assigned by the audio channel assignment module 1016. This allows other attendees the option of listening to both speak or selecting one to listen to by listening to only the right or left channel. In in some embodiments, the audio channel assignment module 1016 sends the audio from the two speaking attendees to respective different audio channels, but the channel that one attendee is on may differ for different attendees based on where the two speaking attendees are displayed.

In some embodiments, the simultaneous speech detection module 1014 and audio channel assignment module 1016 operate in a second free chat mode. In the second free chat mode, the simultaneous speech detection module 1014 detects when more than two attendees are speaking at the same time and the audio channel assignment module 1016 reacts by sending audio from one of the speaking attendees to the left audio channel, sending audio from another speaking attendee to the right audio channel, and converting the speech from other speaking attendees to text that is displayed.

In some embodiments, the simultaneous speech detection module simultaneous speech detection module 1014 and audio channel assignment module 1016 operate in a unified mode. In the unified mode, the simultaneous speech detection module 1014 ranks the attendees by calculating the weighted sum of all attendees' settings for virtual distances to others. The simultaneous speech detection module 1014 renders virtual environments that are customized for, and displayed to, each of the attendees. Each virtual environment has a unique arrangement of other attendees at various distances as described in connection with FIG. 5. Thus, all attendees have their own set of distance settings for the other attendees. In the illustrated embodiment, the simultaneous speech detection module 1014 calculates a weighted sum that results in an ordered list. When the simultaneous speech detection module 1014 thereafter detects that more than two attendees are speaking at the same time, the audio channel assignment module 1016 reacts by sending audio from one of the speaking attendees to the left audio channel, sending audio from another speaking attendee to the right audio channel, and converting the speech from other speaking attendees to text that is displayed. In the unified mode, the audio channel assignment module 1016 determines which two attendees will have their speech sent to the left or right audio channel based on the ordered list.

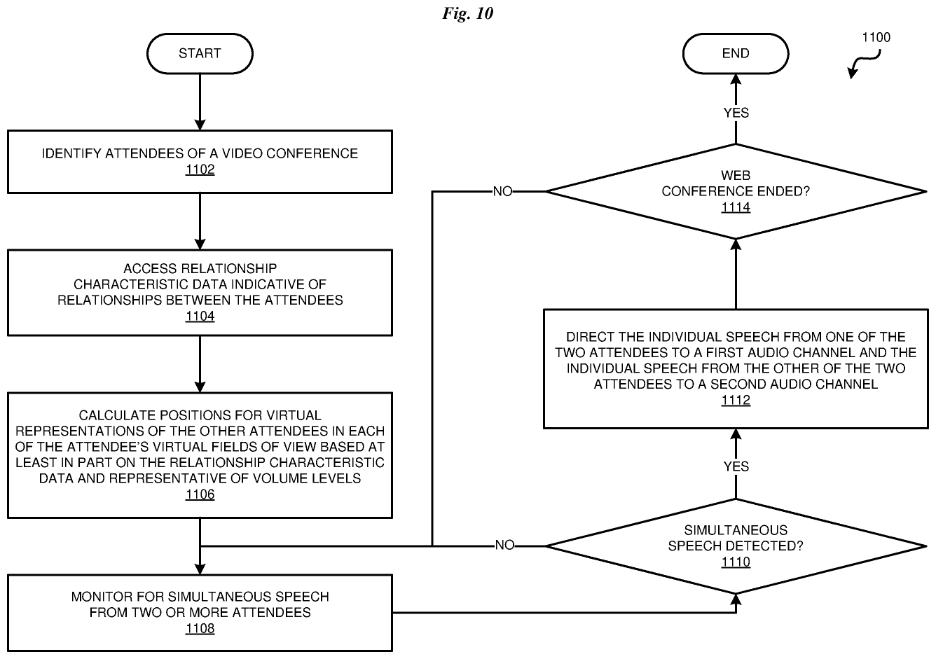

With reference to FIG. 10, this figure depicts a flowchart of an example process 1100 for managing audio conflicts in web conferences in accordance with an illustrative embodiment. In a particular embodiment, the audio management system 1000 carries out the process 1100.

In an embodiment, at block 1102, the process identifies attendees of a video conference and then, at block 1104, determines the relationship characteristics between the identified attendees based on relationship characteristic data, for example from social network data and/or historical meeting data. In some embodiments, the process accesses the social network data that is representative of social network relationships between the each of the attendees.

In some embodiments, the process calculates degrees of associations between each attendee and each of the other attendees based at least in part on the social network relationship data. For example, in some embodiments, the process calculates degrees of associations based on whether another attendee is an immediate friends (or acquaintance) of another attendee, or a friend of an attendee immediate friends, or a member of a same affinity group as another attendee, or a member of a directly-related affinity group, etc. In various embodiments, the degrees of associations between different attendees may be different depending upon which metrics for relationship characteristics are used.

In some embodiments, the process calculates degrees of associations between each attendee and each of the other attendees based at least in part on other data, such as historical meeting data or other data that may be indicative of relationships, common goals, common interests, etc. For example, in some embodiments, the process may assign numeric values associated with the similarities such as attendees that have historically attended the same meetings because they work in a same group or department, work on a same project, or have similar work-related goals or interests. In some embodiments, the process may consider data indicative of the “importance” of the relationships between the attendees based on the frequency of communications between the attendees, the frequency and/or quality of business relationships between the attendees, and the like.

Next, at block 1106, the process calculates positions for virtual representations of the other attendees in each of the attendee's virtual fields of view based at least in part on the relationship characteristic data and representative of volume levels.

Next, at block 1108, the process monitors audio on ongoing web conference for simultaneous speech from two or more attendees. At decision block 1110, if simultaneous speech from two or more attendees is detected, then the process proceeds to block 1112.

At block 1112, in response to detecting speech from two or more attendees, the process directs the individual speech from one of the two attendees to a first audio channel and the individual speech from the other of the two attendees to a second audio channel. Then, at decision block 1114, if the web conference ends, then the process 1100 ends. Otherwise, if “NO” at block 1110 or block 1114, the process returns to block 1108.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer implemented method comprising:
identifying, during a video conference attended by a first attendee, other attendees of the video conference;
rendering, during the video conference as a display to the first attendee, a virtual meeting environment including virtual representations of the other attendees of the video conference,
wherein the rendering comprises:
accessing relationship characteristic data indicative of relationships between the first attendee and the other attendees; and
calculating positions for virtual representations of the other attendees in the first attendee's virtual field of view based at least in part on the relationship characteristic data;
detecting, in speech streamed to the first attendee during the video conference, simultaneous speech from at least two of the other attendees,
wherein the simultaneous speech comprises individual speech from a second attendee and individual speech from a third attendee; and
directing, responsive to detecting the simultaneous speech, the individual speech from the second attendee to a first audio channel and the individual speech from the third attendee to a second audio channel.

2. The computer implemented method of claim 1, further comprising:
accessing priority data generated in response to priority inputs from the first attendee indicative of priority values for the second attendee and the third attendee that prioritize the second attendee and the third attendee above the other attendees.

3. The computer implemented method of claim 2, further comprising:
detecting that the simultaneous speech further comprises individual speech from a fourth attendee; and
converting the individual speech from the fourth attendee to text.

4. The computer implemented method of claim 3, further comprising:
accessing priority data generated in response to priority inputs from the first attendee indicative of a priority value for the fourth attendee that prioritizes the fourth attendee below the second attendee and the third attendee.

5. The computer implemented method of claim 1, wherein the accessing of the relationship characteristic data comprises accessing social network data representative of social network relationships between the first attendee and the other attendees.

6. The computer implemented method of claim 5, further comprising:
calculating degrees of associations between the first attendee and the other attendees based at least in part on the social network relationships.

7. The computer implemented method of claim 6, wherein the accessing of the relationship characteristic data comprises accessing meeting data representative of common interests in topics of the video conference between the first attendee and the other attendees.

8. The computer implemented method of claim 7, further comprising:
calculating degrees of associations between the first attendee and the other attendees based at least in part on the social network relationships and common interests in the topics of the video conference.

9. The computer implemented method of claim 8, wherein the calculating of the positions for virtual representations of the other attendees is based at least in part on respective degrees of associations between the first attendee and the other attendees.

10. The computer implemented method of claim 9, wherein the calculating of the positions for virtual representations of the other attendees comprises calculating virtual distances in the virtual environment between the first attendee and each of the positions of the virtual representations of the other attendees.

11. The computer implemented method of claim 10, wherein the calculating of the virtual distances comprises calculating a virtual distance between the first attendee and a virtual representation of a fourth attendee, wherein the method further comprises:
detecting, in the speech streamed to the first attendee during the video conference, speech from the fourth attendee; and
setting a volume of the speech from the fourth attendee based at least in part on the virtual distance between the first attendee and the virtual representation of the fourth attendee.

12. A computer program product comprising one or more computer readable storage media, and program instructions collectively stored on the one or more computer readable storage media, the program instructions executable by a processor to cause the processor to perform operations comprising:
identifying, during a video conference attended by a first attendee, other attendees of the video conference;
rendering, during the video conference as a display to the first attendee, a virtual meeting environment including virtual representations of the other attendees of the video conference,
wherein the rendering comprises:
accessing relationship characteristic data indicative of relationships between the first attendee and the other attendees; and
calculating positions for virtual representations of the other attendees in the first attendee's virtual field of view based at least in part on the relationship characteristic data;
detecting, in speech streamed to the first attendee during the video conference, simultaneous speech from at least two of the other attendees,
wherein the simultaneous speech comprises individual speech from a second attendee and individual speech from a third attendee; and
directing, responsive to detecting the simultaneous speech, the individual speech from the second attendee to a first audio channel and the individual speech from the third attendee to a second audio channel.

13. The computer program product of claim 12, wherein the stored program instructions are stored in a computer readable storage device in a data processing system, and wherein the stored program instructions are transferred over a network from a remote data processing system.

14. The computer program product of claim 12, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

15. The computer program product of claim 12, further comprising:
accessing priority data generated in response to priority inputs from the first attendee indicative of priority values for the second attendee and the third attendee that prioritize the second attendee and the third attendee above the other attendees.

16. The computer program product of claim 15, further comprising:
detecting that the simultaneous speech further comprises individual speech from a fourth attendee; and
converting the individual speech from the fourth attendee to text.

17. The computer program product of claim 16, further comprising:
accessing priority data generated in response to priority inputs from the first attendee indicative of a priority value for the fourth attendee that prioritizes the fourth attendee below the second attendee and the third attendee.

18. The computer program product of claim 12, wherein the accessing of the relationship characteristic data comprises accessing social network data representative of social network relationships between the first attendee and the other attendees.

19. The computer program product of claim 18, further comprising:
calculating degrees of associations between the first attendee and the other attendees based at least in part on the social network relationships.

20. A computer system comprising a processor and one or more computer readable storage media, and program instructions collectively stored on the one or more computer readable storage media, the program instructions executable by the processor to cause the processor to perform operations comprising:
identifying, during a video conference attended by a first attendee, other attendees of the video conference;
rendering, during the video conference as a display to the first attendee, a virtual meeting environment including virtual representations of the other attendees of the video conference,
wherein the rendering comprises:
accessing relationship characteristic data indicative of relationships between the first attendee and the other attendees; and
calculating positions for virtual representations of the other attendees in the first attendee's virtual field of view based at least in part on the relationship characteristic data;
detecting, in speech streamed to the first attendee during the video conference, simultaneous speech from at least two of the other attendees,
wherein the simultaneous speech comprises individual speech from a second attendee and individual speech from a third attendee; and
directing, responsive to detecting the simultaneous speech, the individual speech from the second attendee to a first audio channel and the individual speech from the third attendee to a second audio channel.
